(19) United States
(12) Patent Application Publication
(10) Pub. No.: US 2010/0102567 A1
(43) Pub. Date: Apr. 29, 2010

(54) Aqua Aura Power Generation Process

(76) Inventor: Rodney C. Nash, Novato, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/505,678

(22) Filed: Jul. 20, 2009

Related U.S. Application Data
(60) Provisional application No. 61/107,961, filed on Oct. 23, 2008.

(51) Int. Cl. F03B 13/10

(52) U.S. Cl. 290/54

(57) ABSTRACT

A power generation assembly is submerged in water and receives potential energy in the form of harnessed buoyancy force that is established and sustained through manipulation of materials of various densities. By use of forces created by the interactions of buoyancy, mass displacement, gravity, leverage and other forces, the captured forces are converted into mechanical energy which in turn is used to create electrical energy. In one embodiment, the invention creates electricity by use of the force exerted when buoyancy is established, harnessed and sustained with the use of fluids or gasses of specified densities that optimize the force of gravity and an equal and opposite force, buoyancy to create the largest possible difference in relative density of components simultaneously used within the process. In general, and by way of example, less dense air is released through piping conveyance within a bottom portion of a basin or tank with said basin being previously filled with a fluid of higher density. Upon release of the less dense air or gas, the less dense air, gas or other Less Dense Material, (LDM) will be forced in an upward direction while the higher dense material, (HDM) such as water or sea water or other liquid) is displaced and forced into downward direction do to gravity. The combined upward buoyancy force and downward gravity force acting through air and water is used to induce movement of a turbine, rotation of attached gearing, and subsequent generator power head, dynamo, alternator, and other means which in turn generates electricity.

### RELATED PATENT APPLICATION AND INCORPORATION BY REFERENCE

This is a utility application based upon U.S. patent application Ser. No. 61/107,961, entitled “MicroHydro Power Generation Process” filed on Oct. 23, 2008. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all patents, patent applications, and other documents hard copy or electronic, cited or referred to in this application.

### BACKGROUND OF THE INVENTION

(1) Field of the Invention

The invention relates generally to remote power generators. More particularly, the invention relates to means and methods of using compressed fluids, gases or other forms of potential energy to generate electrical energy.

(2) Description of the Related Art

The known related art fails to provide practical means of converting potential energy, such as compressed fluids or gas into electrical energy.

### BRIEF SUMMARY OF THE INVENTION

The present invention overcomes shortfalls in the related art by presenting an unobvious and unique combination and configuration of compressed air, compressed fluids, mechanical air compressors, turbines and other components. The present invention achieves various results, including but not limited to:

1. High efficiencies in converting potential energy into mechanical energy;

2. Low costs in construction as compared to alternative power generators; and

3. Provides efficient use of space, as the disclosed generation system operation unit may be installed under water in such locations as existing lakes, ponds, in above and below ground tanks and other bodies of controlled water.

In general, the invention uses a basin or other container within which to introduce material of a relatively higher (MDM) density (to the full sections of the basin) by filling it with (MDM) liquid and then introduces a material of a relatively lower (LDM) density at the bottom section of the basin. A turbine wheel, turbine wheel column, turbine conveyor or other mechanical mechanism is moved by the forces of the less dense material being forced in an upward direction within the presence of the more dense material and more dense material being forced or displaced in a downward direction due to gravity. The invention contemplates the use of one or more turbine wheel columns or turbine wheel conveyors in a variety of configurations to harness the various forces exerted within the basin.

The invention includes a as part of the operation unit a unique column turbine designed to harness the upward movement of LDM occurring within a basin. The disclosed turbine wheel column features multiple side walls that encase energy capture scoops. The sidewalls focus the rising LDM in a vertical direction and allow for multiple turbines to capture and hold the same rising (LDM) particles.

The invention contemplates the use of solar power or other renewable means to compress air and move the air to the bottom sections of the basin. The compressed air may be stored for an indefinite period of time, functioning as a mechanical battery allowing for the disclosed system to be used an emergency backup generator.

### BRIEF DESCRIPTION OF THE DRAWINGS

FIG. 1 is a perspective view of a single turbine wheel

FIG. 2 is a perspective view of a turbine wheel column constructed in accordance with the principles of the invention.

FIG. 3 is a sectional view of a four tier stacked configuration of turbines wheel columns constructed in accordance with the principles of the invention.

FIG. 4 is a perspective view of a two tier stacked configuration commercial scale power generation unit built in accordance with the principles of the invention.

FIG. 5 is a sectional and enlarged view of a turbine wheel conveyor configuration built in accordance with the principals of the invention.

FIG. 6 is a sectional view of a partial sub-grade basin with multiple turbine wheel conveyor configuration of a utility scale power generation system built in accordance with the principles of the invention.

FIG. 7 is a perspective view of a partial sub-grade basin with multiple turbine wheel conveyor configuration of a utility scale power generation system built in accordance with the principles of the invention.

### REFERENCE NUMERALS IN THE DRAWINGS

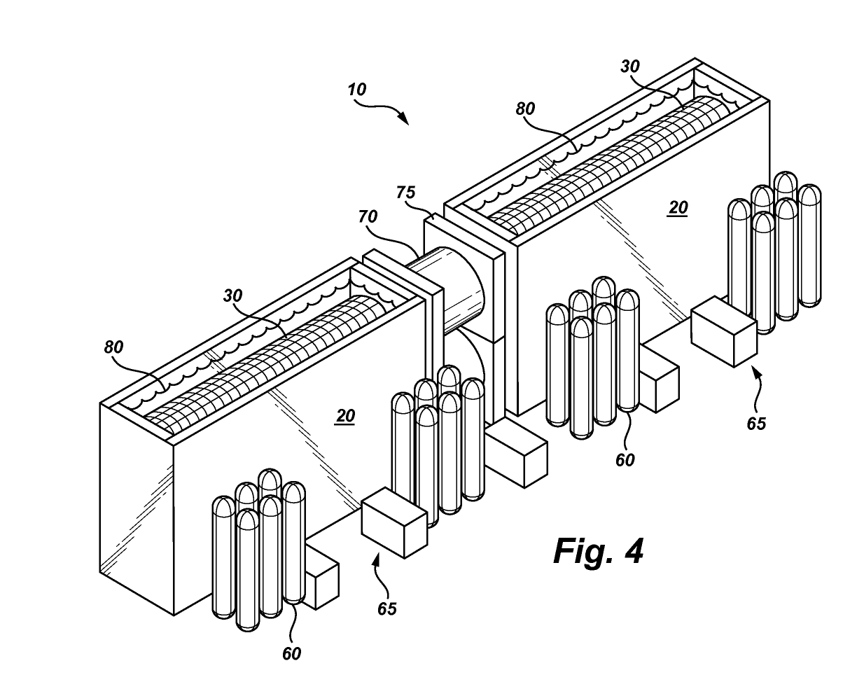

10 an embodiment of the invention in general, shown in FIG. 4

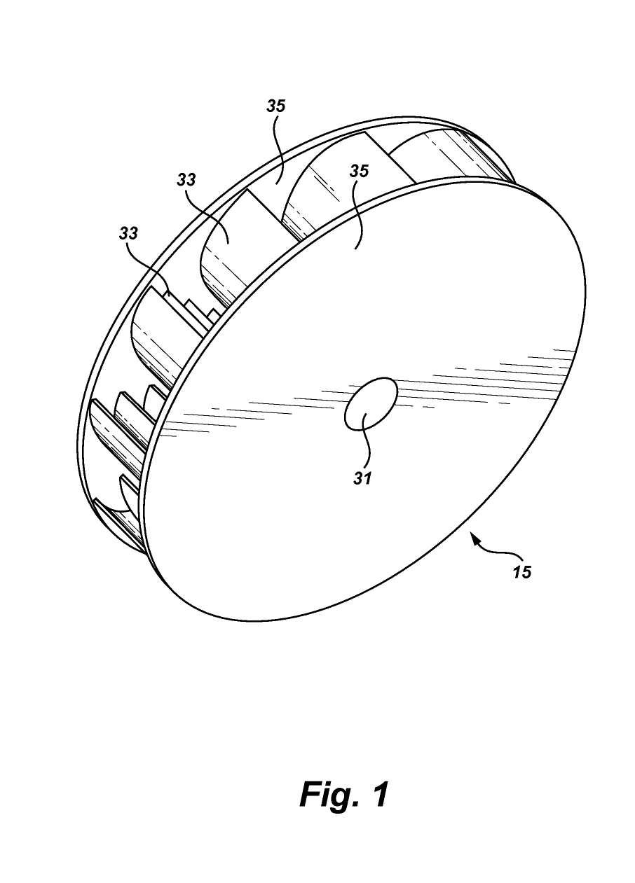

15 an individual base unit turbine wheel, shown in FIG. 1

20 above ground basin or tank, FIG. 4

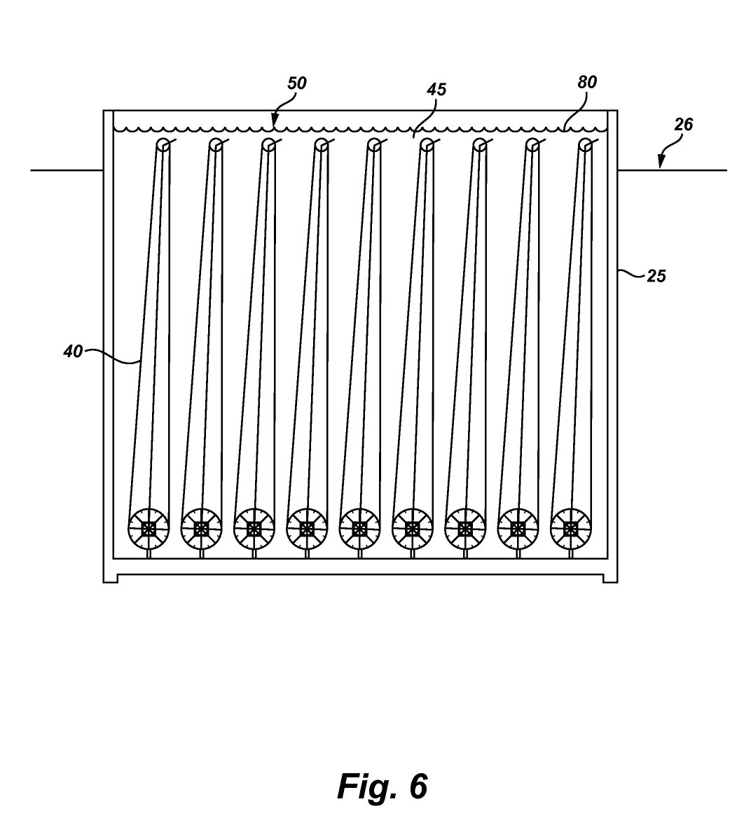

25 below ground basin or tank, FIG. 6

26 ground level, FIGS. 6 & 7

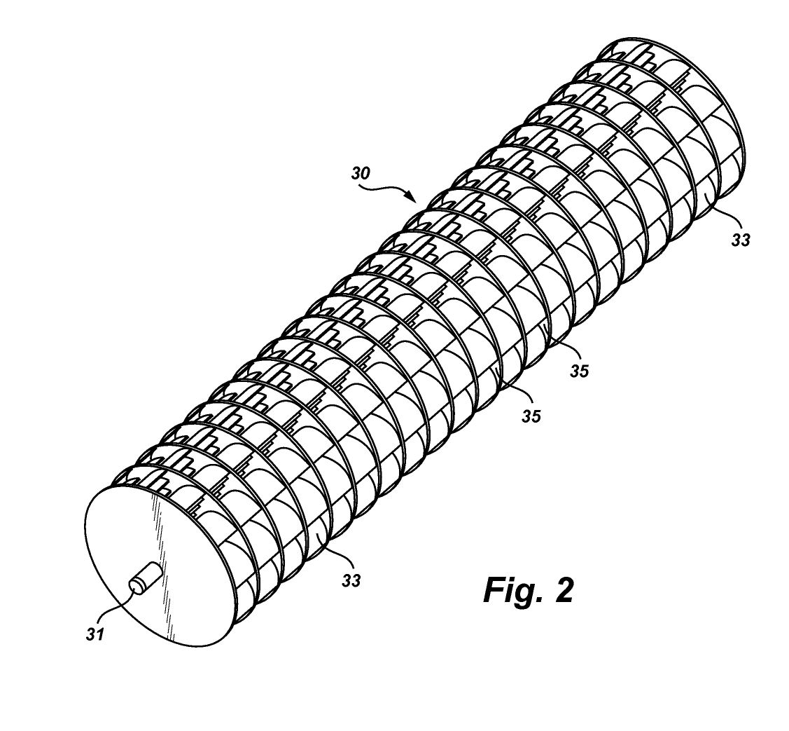

30 turbine wheel columns, FIG. 2

31 shaft or center end section of a column turbine, where shaft could attach to gearbox to turn a electric power generator, FIG. 2

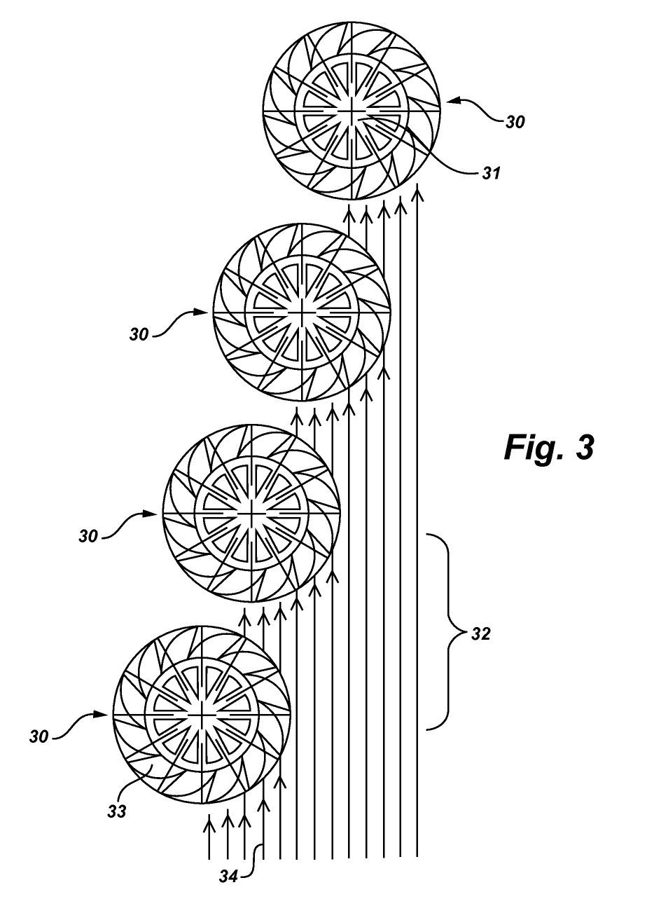

32 arrows representing upward forces of rising air from bottom of basin, FIG. 3

33 capture scoops of the turbines, FIGS. 1-3

34 single upward vector of column of rising air bubbles, shown to power the first two lower turbines of FIG. 3. Vectors of bubble formed at lower level turbine wheel reset to form columns of bubbles to provide new vectors of bubble to upper tier turbine wheel.

35 multiple side walls separating air capture scoops 33 of the turbine wheels 30, FIGS. 1 and 2

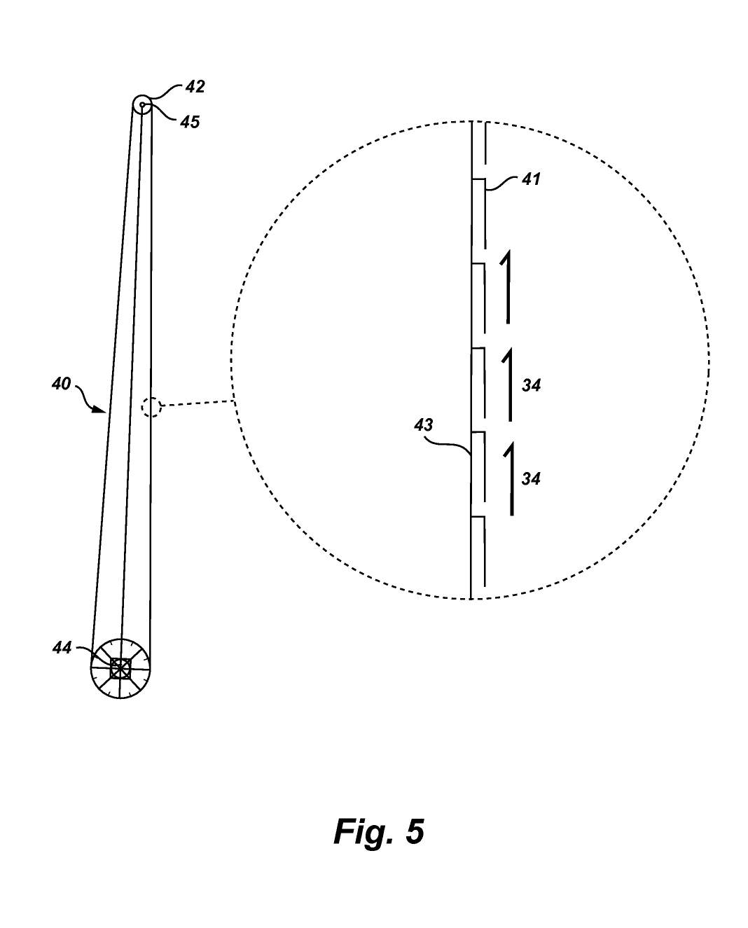

40 individual base unit turbine wheel conveyor, FIG. 5

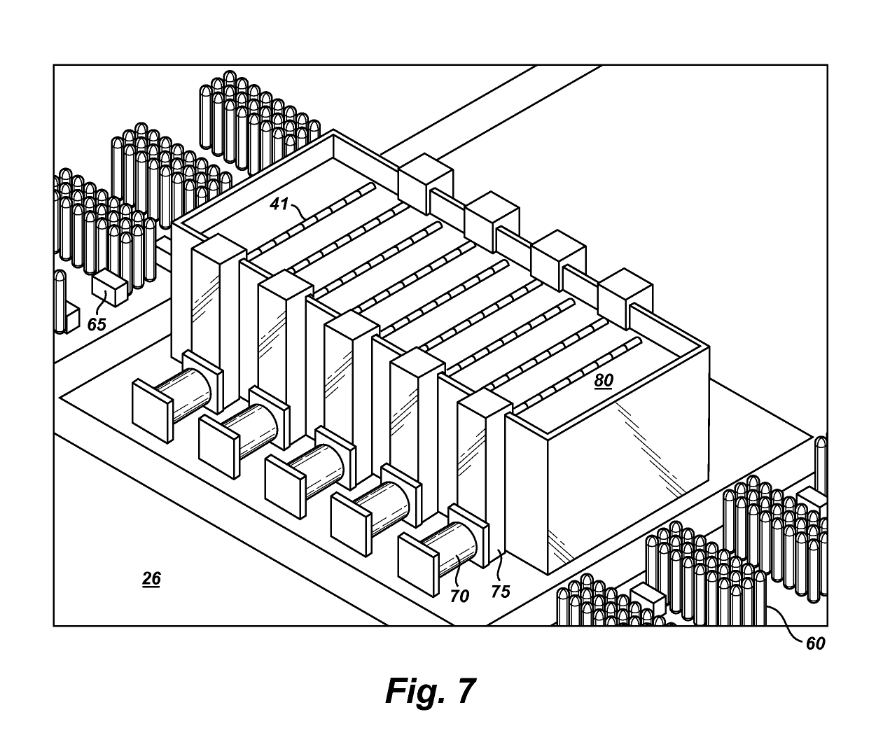

41 conveyor turbine scoops with side walls, FIG. 7

42 upper roller gear, FIG. 5

43 conveyor chain or belt, FIG. 5

44 lower roller gear, FIG. 4 height

45 upper shaft, FIG. 5

50 array of turbine wheel conveyors, FIG. 6

60 gas or air storage tanks, FIG. 4

65 gas or air compressors, FIG. 4

70 power head of generator set, FIGS. 4 and 7

71 footings and supports, FIG. 7

75 gear housing structure used to contain gears and shaft connecting turbine, shaft and power generator shown in FIGS. 4 and 7

80 fluid, such as water or other fluid of relatively high density stored within the basin 20 and basin 25, FIG. 7

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein”, “above”, “below”, and words of similar import, when used in this application, shall refer to this application as a whole and not to any particular portions of this application.

Referring to FIG. 1 is a perspective view of the base unit turbine wheel. By connecting more then one turbine wheel 15 together, a column of turbine wheels 30 (FIG. 2) can be formed to produce an operation unit of greater work potential. This typical configuration of the turbine wheel shows 33 internal fins and partitions as well as 35 side wall which contain buoyant LDM.

FIG. 2 is a perspective view of a column turbine wheel 30 with exposed capture scoops 33 and multiple side walls 35 which act to separate the capture scoops. Moreover, the multiple capture scoops and side walls capture and hold the force of the rising gas or air which is equal to the displaced fluid or water from the submerged capture scoops. Without the multiple side walls 35 rising gasses could simply move laterally and then upward before rotating the scoops of the turbine. The lateral movement of gases would prevent the multiple use of gasses as shown in FIG. 3 wherein vertical vector columns formed by gasses release from lowest turbine wheel column form multiple upward vector such as 34 and turn more than one turbine. The lower left hand corner of FIG. 2 contains shaft at center of turbine wheel column 30 which is where a shaft is attached that connects to gearbox for a electric power generator or other energy conversion system.

FIG. 3 is a sectional view of a four tier column turbine array positioned to capture the force of rising gases or fluids in order to turn a center shaft, set at center axis of 31 of each connected turbine wheel column. Upward arrows 32 represent gasses or air moving in an upward direction and moving into the capture scoops 33 of the turbine wheels. The disclosed multi-tier configuration of turbines allows for the multiple use of bubbling air particles to move one or more turbines. For example, upward arrow 34 is shown intersecting with the two lower column turbines in FIG. 3. A large portion of this air would move upward from the third lowest turbine to the second lowest and be repeated for each upper tier of turbine wheel columns multiple times.

Referring to FIG. 4, one possible configuration of the disclosed system 10 is presented in an above ground configuration where the basin 20 is above ground. In alternative embodiments, the basin 20 may comprise four or five closed sides placed in the ground or below ground 25, beneath or within a body of open water. In such an alternative embodiment and as shown, the air compressors 65 would be located on the operation unit above the water surface or above grade while the compressed air tanks 60 could be located either above or below the water surface ground level respectively. In the embodiment, turbine wheel column turbines 30 would still be contained within the basin 20 submerged below 80 water or similar relatively HDM and each column turbine 30 would be connected to a gearbox 75 to turn a power generator 70 to produce electricity or otherwise convert mechanical energy into another form of energy. In FIG. 4, an above ground embodiment is shown with air compressors 65 and compressed air storage tanks 60 stationed on ground level.

FIG. 5 is a base and enlarged sectional view of a 40 conveyor turbine. The embodiment of the invention wherein turbine capture scoops 41 are attached to conveyor with mechanical mechanism which provide for capture of upward bound bubbles and associated 34 vertical force vectors. This embodiment functions through the use of scoops and scoop side walls, that allow articulation of scoops 41 around and along mechanical appendages such as conveyor gear rollers 42 and 44, and that holds each individual scoop in a vertically orientated conveyor assembly. The capture scoops in this configuration are attached to chain through connection rod or other similar mechanical conveyor 43 means such as pulley or other connection previously described mechanical function. The conveyor turbine is connected to shaft 45 via roller gear assembly which connects to a gearbox for turning electric power generator or other energy conversion system.

FIG. 6 is a sectional view of a nine conveyor turbine embodiment of the invention array 50 of an in ground basin 25, in which the majority of the basin is below 26 grade level. The conveyor turbine scoops are attached to vertically orientated conveyor type mechanism and capture the force of rising gases or fluids in order to indirectly turn the upper drive shaft 45 which is connected to roller 42. The roller assembly 42 and 44 is connected to upper drive shaft, through gear rollers, pass shaft. In this configuration, the scoops are submerged under water or other HDM 80, and move upward as the air captured in this method remains captured for a longer period of time and moves upward from the bottom of the basin, until released at the upper roller in the system Each turbine conveyor 40 is connected to independent shaft which connects to a gearbox for turning electric power generator or other energy conversion system. Multiple shaft outputs may be combined to single gear drive to provide single drive input to electric power generator.

Referring to FIG. 7, a second possible configuration of the disclosed system 10 is presented in this perspective view of a partially below ground embodiment of the invention wherein conveyor turbine scoops attached to vertically orientated conveyor type mechanism shown in FIG. 6, 25. The very top of scoop assembly 41, less than 2% of conveyor turbine is exposed above water level 80 around upper roller 42. The end of each column of turbine conveyor connects to gearbox 75 and a shaft leading to power generators 70 resting above upon the ground 26. The gearing and shaft components are contained within gear housing structure 75.

### OTHER ASPECTS OF THE INVENTION

The invention contemplates the fabrication of small to medium scale embodiments of the disclosed systems such that families, neighborhoods or small commercial entities may economically and reliably produce their own electrical energy. In their simplest forms, the disclosed systems create mechanical energy by the introduction of air or other less dense matter (LDM) into the bottom section of a basin containing a MDM fluid. Advantages over the known prior art are achieved by, inter alia, the use of staggered, multi-tiered column turbines, FIG. 4 or the use of multiple column conveyor turbine FIG. 7, both configuration utilizing scoops with multiple side walls 35 which keep the air or light gas particles in a relatively vertical and upward flow such that more than one turbine wheel column may be powered from gas particles of lower positioned turning wheel as shown by upward force vectors 34 of FIG. 3 or holding captured air or light gas particles in a relatively vertical and upward flow such that one conveyor turbine column may be powered from gas particles captured at lower positioned of conveyor and held until they reach the very highest possible level in the basin, turning the conveyor as shown by upward force vectors 34 of FIG. 5

The disclosed systems have multiple facets of utility that do not rely upon the system operating the air compressors or otherwise providing power to introduce light gas (LDM) or air to the bottom of the basins. In various embodiments, the principles of the invention may be employed in conjunction with a solar or wind powered electrical generation system. For example, a solar or wind generation system may be used to provide electrical power to air compressors to deliver air or compressed gas directly to the bottom of the basin through piping. Or, a solar or wind generation system may be used to provide electrical power to compress and deliver air or compressed gas into gas or air storage tanks 40, such that the stored air or gas may be released into the system at night or during periods of little wind. Such a system would avoid the use of lead and other toxic chemical commonly found in battery systems currently used with wind and solar power systems by using the stored as a mechanical battery.

In certain aspects, the disclosed systems may be considered to be based upon the fundamental essence of Archimedes Principle along with Newton's Second and Third Law of Motion. The disclosed systems creates or initiates, then harnesses the force vectors created when buoyancy is established and sustained with the use of specific fluids and or gases that optimize the use of the force of gravity and its equal and opposite force, buoyancy to generate the movement or displacement of fluids; this displacement or work is captured by the disclosed turbine wheel column or conveyor turbine. Turbine wheels columns or conveyor turbines provide shaft rotation induced by force vectors. The application of buoyancy force vectors that are offset, perpendicular and parallel to shaft, at a specific location, angle and distance from said shaft induces sustained shaft rotation.

The invention comprises, but is not limited to the following components or features:

1. Generation of power by harnessing forces created through the means of injection of a less dense fluids or gases into a container that already containing fluids or gases of higher density. The forces of gravity and buoyancy act on the fluids/gases combination to establish an upward buoyancy force vector encompassed in displacement or movement of more dense particles downward and the less dense particles upward.

2. A method of generating power, the method comprising the steps of harnessing a buoyancy force by directing the buoyancy force to a position with respect to a turbine wheel column(s) or conveyor turbine, thus creating capture scoop uplift, column or conveyor rotation, torque that is offset, perpendicular to the shaft and parallel along a shaft axis, with the shaft axis energizing a gearbox and electrical power generator.

The buoyancy force used by the turbine is directly proportional to the volume of material being displaced, relative density of the material being displaced and density of the material performing the displacement. The constant force of gravity and buoyancy act in an equal and opposite directions along a vertical axis. Other variables that contribute to or increase or decrease the buoyancy of particles of fluids/gases (bubbles) within the basin include temperature of fluids, gases, and size of the particles.

3. A power generation system comprising:

a) injection of compressed air or other liquid or gaseous material of relatively low density at depth into a basin containing water or other liquid or gaseous material of relatively higher density;

b) placement of turbine wheel column or conveyor turbine mechanism at shallower depth to capture or otherwise trap gaseous particles as they rise into capture scoops due to upward movement of buoyant particles of LDM medium caused by displacement of HDM medium, causing rotation of capture scoops attached to wheel, shaft, conveyor or other type of mechanism; and

c) attachment of a turbine wheel column or conveyor turbine to an axle shaft and gear box, wherein the shaft may rotate based on force input vectors from the offset scoops which move perpendicular to the shaft axis and are parallel along shaft axis allowing axis to comport with the movement of the captured buoyancy force on the wheel or turbine.

4. The generation of mechanical power and thus electrical power by use of non thermal force via fluid dynamics (by use of gravity and buoyancy) to a mechanical force.

The disclosed systems observe Newton's second law Fₙₑₜ=ma which states that force is the product of mass and acceleration and Newton's third law, −Fₙₑₜ=+Fₙₑₜ which states that for every action or force there is an equal and opposite reaction or force. Newton theorizes that the uplift force or buoyancy is directly proportional and opposite to force of gravity.

The greater the density delta, the greater the displacement, and the greater force applied to cross sectional area (sq.m.) or volume (cu.m.) of flywheel turbine blade is significantly greater then the force or energy used to create compressed gas.

### EXAMPLE

Density of water is 1000 kg/m̂3
Density of air is 1.2 kg/m̂3

The disclosure further observers that:

Archimedes teaches that the act of the displacement of fluid is work, or per Newton, the downward “acceleration of mass”, displaced in a direction opposite buoyancy, gravity. The net upward buoyancy force is equal to the magnitude of the mass accelerated by gravity of the fluid displaced by the introduced body present; in this case—displaced mass is denser water and buoyancy gas is air. Specifically Fₙₑₜ=mg−pvg or Fₙₑₜ=pVg
(p=material density, V=Volume, g=gravity constant)

Net Force (Fₙₑₜ) yielded is equal to displaced mass times gravity minus density of fluid/gas being displaced times volume of displaced fluid/gas times gravity. Mass being moved is force in action or work being done. Increasing the volume of displaced higher density fluid/gas increases buoyancy force and thus torque along shaft axis subsequently connected to gearbox and electrical generator; thus an increase in energy harnessed and potential power generated.

H20=8.35 lbs/Gal: 1 cu.ft=62.37 lbs:

Ideally, use of solar or wind power, or other renewable energy source is used to start power production cycle; to run starter series of air compressor; to make electricity to produce hydrogen fuel which will run second series air compressors. For grid power production it is ideal to store compressed air to run generators in this power production process when no sun or wind is present. It is intended that the primary fuel that runs utility scale high volume compressors be hydrogen.

Under specified system design & engineering standards, electricity produced is enough to create net energy yields of multiple times internal system load, which is primarily air production. Established ratios of energy input to energy output; the energy needed to compress sufficient volume of air and deliver to turbine column and conveyor turbine to turn shaft and gearbox to generate specified rpm to electric generator vs. the energy yielded from the generator during given duty cycle prove the processes internal efficiency and thus the overall process and configuration and mechanical system is very efficient and economical from an energy resources, environmental and financial feasibility perspective. Capturing the mechanical force created by continuous injection of a LDM compressed fluid/gas into higher density fluid/gas at depth with a plurality of turbine scoops at a specified distance from centered axel transfers the power of the captured force from turbine to axel torque to gearbox and electrical generator at specified rpm to produce continuous, to provide stable, sustainable, economical, renewable electricity.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications, if any, are incorporated herein by reference. Aspects of the invention can be modified, if necessary, to employ the systems, functions and concepts of the various patents and applications described above to provide yet further embodiments of the invention.

### ITEMS

The invention includes, but is not limited to the following items:

Item 1. A system of producing power, the system comprising:

a) a basin 20, 25, with means to contain water and with means to secure a column turbine or turbine conveyor;

b) a plurality of column turbines 30 or conveyor turbines 50, with each column or conveyor turbine having more than one row of capture scoops 33, 41, flanked with side walls 35 separating the capture scoops;

c) the plurality of column or conveyor turbines being configured within given basin 20, 25, such that the turbines do not share a vertical or horizontal position with one another and are further configured in the case of columns such that at least two or more vectors 34 of bubbles or light gas will intersect with two or more column turbines;

d) water 80 or some other relatively dense fluid or gas occupying the basin;

e) means of injecting air or relatively less dense fluid or gas to the bottom of the basin;

f) means to allow the rising air or relatively less dense fluid or gas to turn the plurality of column turbines;

g) means of attachment to the sections 31 of the column or conveyor turbines to attach to shaft, gears, and or other mechanical means to transfer mechanical power from the column or conveyor turbines to one or more electrical power generators 70.

Item 2. The system of item 1 further comprising means of air compression 65, means of compressed air storage 60 and means of compressed air delivery into the bottom section of the basin.

Item 3. The system of item 2 further comprising basins 20, 25 positioned FIGS. 4 and 7 respectively, such that a specified power generator 70, FIG. 4 may be placed between the two basins or at the end of basin.

Item 4. A method of power generation the method comprising the steps of:

a) introducing a gas of a relatively lower density into the bottom of a basin, the basin being prefilled with a gas or liquid of a relatively higher density;

b) attaching a series of column or conveyor turbines within the basin, such that no two column or conveyor turbines share a vertical or horizontal axis;

c) attaching a plurality of capture scoops to the column or conveyor turbines;

d) attaching a plurality of side walls within the capture scoops, such that each capture scoop has a maximum standard, typical and repeated profile;

f) attaching shafts, gears, chains or other necessary mechanical means to transfer movement from the column or conveyor turbine to a electrical power generator;

g) allowing the introduced air to rise and turn the turbine wheel columns to produce mechanical power.

Item 5. The method of item 4 including the steps of:

a) providing air compressor to compress air;

b) providing compressed air storage tank; and

c) compressing air within the air compressor and providing conveyance of air from compressor to the compressed air storage tank.

Item 6. The method of item 5 including the steps of:

a) using solar power or wind power or other alternative power source to provide power to the air compressor and to provide conveyance of compressed air from compressor to the compressed air storage tank; and

b) applying the stored compressed air to the bottom of the basin through conveyance, when the solar power or wind power is not available.

Item 7. The method of item 5 including the steps of:

a) using direct or stored energy from another source to introduce air or gas of lower density to the bottom of the basin;

b) generating power by allowing the air or gas of lower density to lift and turn a turbine column wheel or conveyor turbine; and

c) using electricity generated by the turbine wheel column or turbine column to run the air compressor, convey the compressed air into an air storage tank and to then convey the compressed air from the storage tank to the bottom of the basin.

In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

What is claimed is:

1. A system of producing power, the system comprising:
a) a basin with means to contain water and with means to secure a column or conveyor turbine;
b) a plurality of column or conveyor turbines, with each column or conveyor turbine having more than one row of capture scoops, flanked with side walls separating the capture scoops;
c) the plurality of column or conveyor turbines being configured within the basin such that the turbines do not share a vertical or horizontal position with one another and the case of the turbine column are further configured such that at least two or more vectors of air bubbles or gas will intersect with two or more column turbines;
d) water or some other relatively dense fluid occupying the basin;
e) means of injecting air or relatively less dense material to the bottom of the basin;
f) means to allow the rising air or relatively less dense material to turn the plurality of column or conveyor turbines;
g) means of attachment to the center end sections of the column or conveyor turbines to shaft, gears or other mechanical mechanism to transfer mechanical power from the column or conveyor turbines to one or more electrical power generators.

2. The system of claim 1 further comprising means of air compression, means of compressed air storage and means of conveyance of compressed air into the bottom section of the basin.

3. The system of claim 2 further comprising two basins positioned such that a specified electric power generator may be placed between the two basins.

4. A method of power generation the method comprising the steps of:
a) introducing a gas of a relatively lower density into the bottom of a basin, the basin being prefilled with a gas or liquid of a relatively higher density;
b) attaching a series of column or conveyor turbines within the basin, such that no two column turbines share a vertical or horizontal axis;
c) attaching a plurality of capture scoops to the column or conveyor turbines;
d) attaching a plurality of side walls within the capture scoop;
f) attaching shaft, gears, chains or other necessary mechanical means to transfer movement from the column or conveyor turbines to a electrical power generator;
g) allowing the introduced air to rise and spin the column turbines to produce torque and thus electrical from the power generator.

5. The method of claim 4 including the steps of:
a) providing an air compressor to compress air;
b) providing a compressed air storage tank; and
c) compressing air within the air compressor, conveying the compressed air to the air storage tank.

6. The method of claim 5 including the steps of:
a) using solar power, wind power or other alternative power source to operate the air compressor and to convey the compressed air into the air storage tank; and
b) applying the stored compressed air to the bottom of the basin when the solar power or wind power is not available.

7. The method of claim 5 including the steps of:
a) using stored energy from another source to produce and introduce air or gas of lower density to the bottom of the basin; and
b) generating electrical power by allowing the air or gas of lower density to turn the column or conveyor turbines; and
c) using electrical power generated by the column or conveyor turbines to run the air compressor, convey the compressed air into a air storage tank and to move the air from the storage tank to the bottom of the basin.
